(19) United States
(12) Patent Application Publication
(10) Pub. No.: US 2024/0349327 A1
(43) Pub. Date: Oct. 17, 2024

(54) RESOURCE CONFLICT INDICATIONS FOR SIDELINK RESOURCES

(71) Applicant: QUALCOMM Incorporated, San Diego, CA (US)

(72) Inventors: Hui GUO, Beijing (CN); Tien Viet NGUYEN, Bridgewater, NJ (US); Kapil GULATI, Belle Mead, NJ (US); Shijun WU, San Diego, CA (US); Gabi SARKIS, San Diego, CA (US); Sourjya DUTTA, San Diego, CA (US)

(21) Appl. No.: 18/291,738

(22) PCT Filed: Sep. 6, 2021
(86) PCT No.: PCT/CN2021/116613

§ 371 Date: Jan. 24, 2024

(51) Int. Cl. H04W 72/566; H04L 1/1829; H04W 72/25

(52) U.S. Cl. CPC H04W 72/566; H04L 1/1854; H04W 72/25

(57) ABSTRACT

Various aspects of the present disclosure generally relate to wireless communication. In some aspects, a first user equipment (UE) may receive, from multiple UEs including a second UE, multiple sidelink control informations (SCIs). The UE may select, from multiple resource conflict indications derived from the multiple SCIs, a resource conflict indication based at least in part on a priority scheme. The UE may transmit, to at least one of the multiple UEs including the second UE, the resource conflict indication in accordance with a transmission power level. Numerous other aspects are described.

### FIELD OF THE DISCLOSURE

Aspects of the present disclosure generally relate to wireless communication and to techniques and apparatuses for resource conflict indications for sidelink resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of signaling inter-UE coordination information, in accordance with the present disclosure.

FIG. 4 is a diagram illustrating examples of signaling inter-UE coordination information that indicates resource conflicts, in accordance with the present disclosure.

FIG. 5 is a diagram illustrating an example of signaling a presence of an expected/potential resource conflict, in accordance with the present disclosure.

FIG. 6 is a diagram illustrating an example associated with resource conflict indications for sidelink resources, in accordance with the present disclosure.

FIG. 7 is a diagram illustrating an example process associated with resource conflict indications for sidelink resources, in accordance with the present disclosure.

FIG. 8 is a diagram of an example apparatus for wireless communication, in accordance with the present disclosure.

### SUMMARY

In some implementations, an apparatus for wireless communication at a first user equipment (UE) includes a memory and one or more processors, coupled to the memory, configured to: receive, from multiple UEs including a second UE, multiple sidelink control informations (SCIs): select, from multiple resource conflict indications derived from the multiple SCIs, a resource conflict indication based at least in part on a priority scheme; and transmit, to at least one of the multiple UEs including the second UE, the resource conflict indication in accordance with a transmission power level.

In some implementations, a method of wireless communication performed by a first UE includes receiving, from multiple UEs including a second UE, multiple SCIs; selecting, from multiple resource conflict indications derived from the multiple SCIs, a resource conflict indication based at least in part on a priority scheme; and transmitting, to at least one of the multiple UEs including the second UE, the resource conflict indication in accordance with a transmission power level.

In some implementations, a non-transitory computer-readable medium storing a set of instructions for wireless communication includes one or more instructions that, when executed by one or more processors of a first UE, cause the first UE to: receive, from multiple UEs including a second UE, multiple SCIs: select, from multiple resource conflict indications derived from the multiple SCIs, a resource conflict indication based at least in part on a priority scheme; and transmit, to at least one of the multiple UEs including the second UE, the resource conflict indication in accordance with a transmission power level.

In some implementations, a first apparatus for wireless communication includes means for receiving, from multiple apparatuses including a second apparatus, multiple SCIs: means for selecting, from multiple resource conflict indications derived from the multiple SCIs, a resource conflict indication based at least in part on a priority scheme; and means for transmitting, to at least one of the multiple apparatuses including the second apparatus, the resource conflict indication in accordance with a transmission power level.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

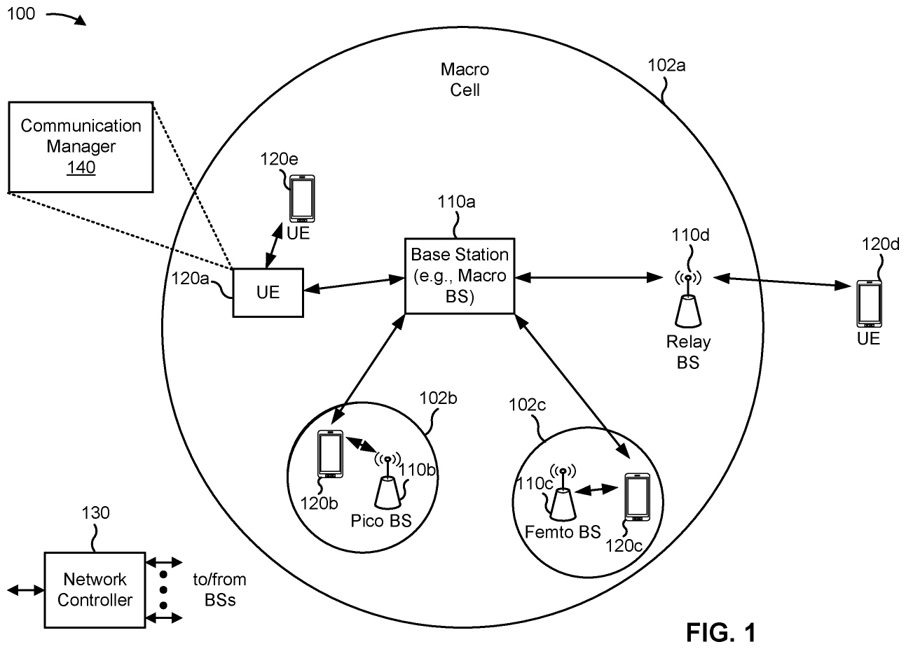

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, a first UE (e.g., 120a) may include a communication manager 140. As described in more detail elsewhere herein, the communication manager 140 may receive, from multiple UEs including a second UE (e.g., UE 120e), multiple sidelink control informations (SCIs): select, from multiple resource conflict indications derived from the multiple SCIs, a resource conflict indication based at least in part on a priority scheme; and transmit, to at least one of the multiple UEs including the second UE, the resource conflict indication in accordance with a transmission power level. Additionally, or alternatively, the communication manager 140 may perform one or more other operations described herein.

As indicated above, FIG. 1 is provided as an example. Other examples may differ from what is described with regard to FIG. 1.

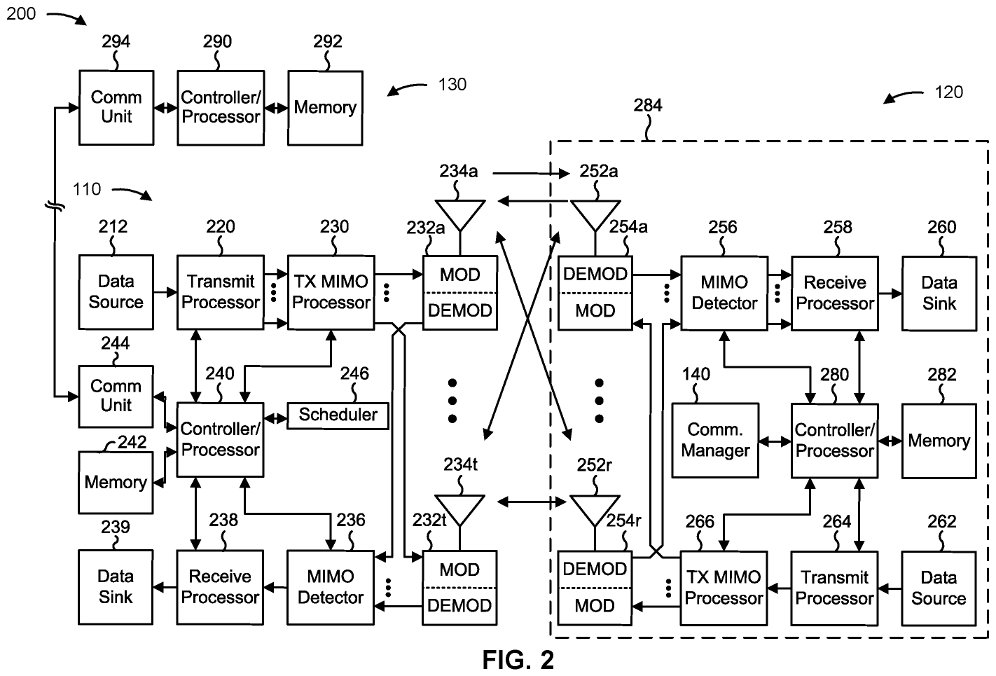

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

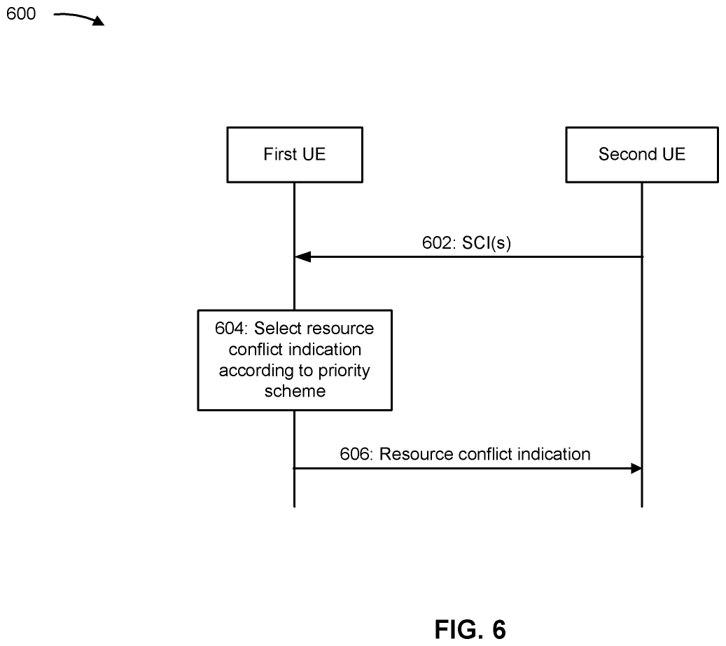

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-8).

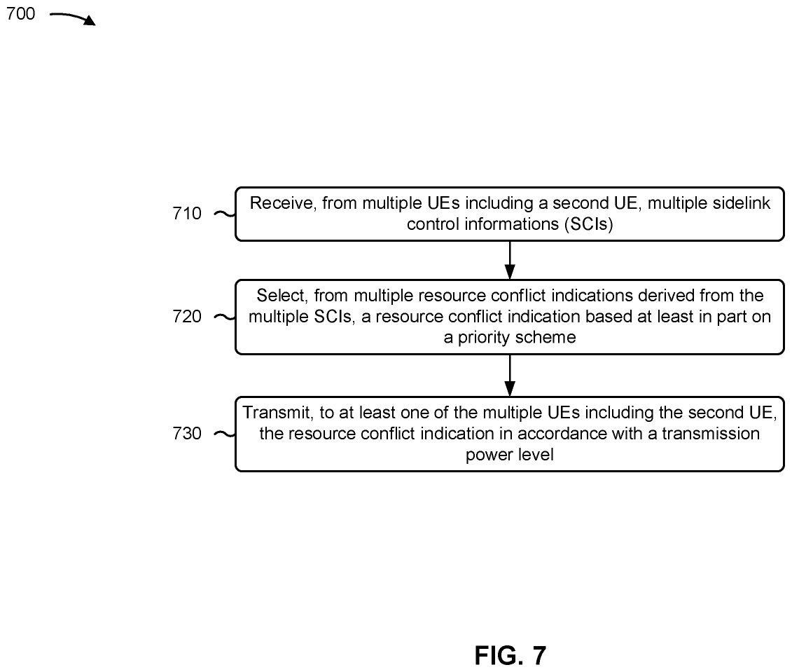

The controller/processor 240 of the base station 110, the controller/processor 280 of the UE 120, and/or any other component(s) of FIG. 2 may perform one or more techniques associated with resource conflict indications for sidelink resources, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, and/or other processes as described herein. In some examples, executing instructions may include running the instructions, converting the instructions, compiling the instructions, and/or interpreting the instructions, among other examples.

In some aspects, a first UE (e.g., UE 120a) includes means for receiving multiple SCIs from multiple UEs including a second UE (e.g., UE 120e); means for selecting, from multiple resource conflict indications derived from the multiple SCIs, a resource conflict indication based at least in part on a priority scheme; and/or means for transmitting, to at least one of the multiple UEs including the second UE, the resource conflict indication in accordance with a transmission power level. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

A first UE (e.g., UE 120a) may communicate with a second UE (e.g., UE 120e) (and one or more other UEs) via one or more sidelink channels. The UEs may communicate using the one or more sidelink channels for P2P communications, D2D communications, V2X communications (e.g., which may include V2V communications, V2I communications, and/or V2P communications) and/or mesh networking. In some aspects, the one or more sidelink channels may use a PC5 interface and/or may operate in a high frequency band (e.g., the 5.9 GHz band). Additionally, or alternatively, the UEs may synchronize timing of transmission time intervals (TTIs) (e.g., frames, subframes, slots, or symbols) using global navigation satellite system (GNSS) timing.

The one or more sidelink channels may include a physical sidelink control channel (PSCCH), a physical sidelink shared channel (PSSCH), and/or a physical sidelink feedback channel (PSFCH). The PSCCH may be used to communicate control information, similar to a physical downlink control channel (PDCCH) and/or a physical uplink control channel (PUCCH) used for cellular communications with a base station 110 via an access link or an access channel. The PSSCH may be used to communicate data, similar to a physical downlink shared channel (PDSCH) and/or a physical uplink shared channel (PUSCH) used for cellular communications with a base station 110 via an access link or an access channel. For example, the PSCCH may carry SCI, which may indicate various control information used for sidelink communications, such as one or more resources (e.g., time resources, frequency resources, and/or spatial resources) where a transport block (TB) may be carried on the PSSCH. The TB may include data. The PSFCH may be used to communicate sidelink feedback, such as hybrid automatic repeat request (HARQ) feedback (e.g., acknowledgement or negative acknowledgement (ACK/NACK) information), transmit power control (TPC), and/or a scheduling request (SR).

The SCI may include multiple communications in different stages, such as a first stage SCI (SCI-1) and a second stage SCI (SCI-2). The SCI-1 may be transmitted on the PSCCH. The SCI-2 may be transmitted on the PSSCH. The SCI-1 may include, for example, an indication of one or more resources (e.g., time resources, frequency resources, and/or spatial resources) on the PSSCH, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH, such as a hybrid automatic repeat request (HARQ) process ID, a new data indicator (NDI), a source identifier, a destination identifier, and/or a channel state information (CSI) report trigger.

The one or more sidelink channels may use resource pools. For example, a scheduling assignment (e.g., included in the SCI) may be transmitted in sub-channels using specific resource blocks (RBs) across time. In some aspects, data transmissions (e.g., on the PSSCH) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE (e.g., UE 120a) may operate using a transmission mode where resource selection and/or scheduling is performed by the UE (e.g., rather than a base station 110). In some aspects, the UE may perform resource selection and/or scheduling by sensing channel availability for transmissions. For example, the UE may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE may perform resource selection and/or scheduling using SCI received in the PSCCH, which may indicate occupied resources and/or channel parameters. Additionally, or alternatively, the UE may perform resource selection and/or scheduling by determining a channel busy rate (CBR) associated with various sidelink channels, which may be used for rate control (e.g., by indicating a maximum number of resource blocks that the UE can use for a particular set of subframes).

In the transmission mode where resource selection and/or scheduling is performed by a UE, the UE may generate sidelink grants, and may transmit the grants in SCI. A sidelink grant may indicate, for example, one or more parameters (e.g., transmission parameters) to be used for an upcoming sidelink transmission, such as one or more resource blocks to be used for the upcoming sidelink transmission on the PSSCH (e.g., for TBs), one or more subframes to be used for the upcoming sidelink transmission, and/or a modulation and coding scheme (MCS) to be used for the upcoming sidelink transmission. In some aspects, a UE may generate a sidelink grant that indicates one or more parameters for semi-persistent scheduling (SPS), such as a periodicity of a sidelink transmission. Additionally, or alternatively, the UE may generate a sidelink grant for event-driven scheduling, such as for an on-demand sidelink message.

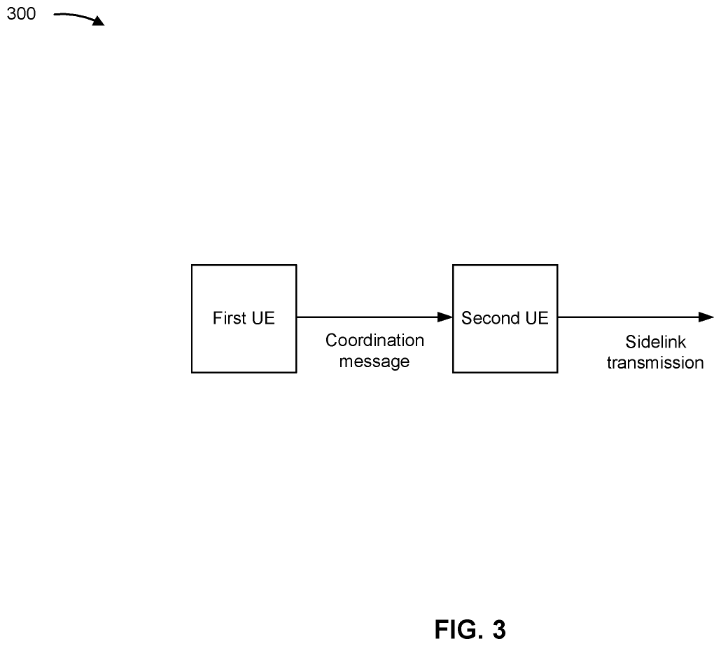

FIG. 3 is a diagram illustrating an example 300 of signaling inter-UE coordination information, in accordance with the present disclosure.

As shown in FIG. 3, a first UE may transmit inter-UE coordination information to a second UE, where the inter-UE coordination information may indicate a set of resources. In a first case, the first UE may transmit to the second UE an indication of a set of resources preferred for the second UE's transmission, where the set of resources may be based at least in part on a sensing performed by the first UE. In a second case, the first UE may transmit to the second UE an indication of a set of resources not preferred for the second UE's transmission, where the set of resources may be based at least in part on the sensing performed by the first UE and/or an expected/potential (expected or potential) resource conflict. In a third case, the first UE may transmit to the second UE an indication of a set of resources for which a resource conflict is detected. The second UE may receive the inter-UE coordination information from the first UE, and the second UE may perform a sidelink transmission based at least in part on the inter-UE coordination information. In other words, the second UE may perform the sidelink transmission based at least in part on the set of resources indicated in the inter-UE coordination information.

As indicated above, FIG. 3 is provided as an example. Other examples may differ from what is described with regard to FIG. 3.

Inter-UE coordination information signaling may indicate sensing, resources, and/or resource conflict information. A pre-collision indication may allow a UE to avoid collisions. A post-collision indication may allow UEs to retransmit after a collision has occurred. A half-duplex indication may allow UEs to retransmit after a conflict has occurred.

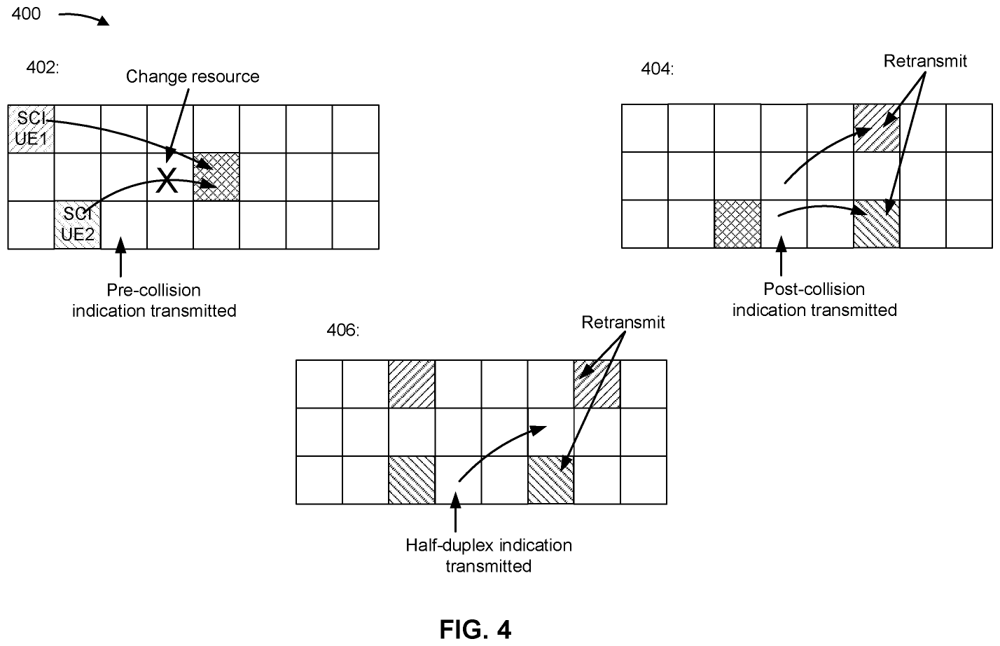

FIG. 4 is a diagram illustrating examples 400 of signaling inter-UE coordination information that indicates resource conflicts, in accordance with the present disclosure.

As shown by reference number 402, a first UE may transmit SCI (e.g., SCI-1 and/or SCI-2) indicating an upcoming resource for a first sidelink transmission. The second UE may transmit SCI indicating an upcoming resource for a second sidelink transmission. The upcoming resource for the first sidelink transmission may collide with the upcoming resource for the second sidelink transmission. The first UE may transmit a pre-collision indication, which may indicate a collision at the upcoming resource between the first sidelink transmission and the second sidelink transmission. The pre-collision indication may be an expected/potential conflict indication. The second UE, after receiving the pre-collision indication, may change the upcoming resource for transmitting the second sidelink transmission. A transmission of the pre-collision indication may trigger the change in resource. As a result, the first UE and the second UE may avoid the collision.

As shown by reference number 404, a collision may occur at a resource between a first sidelink transmission performed by a first UE and a second sidelink transmission performed by a second UE. The first UE may transmit a post-collision indication to the second UE, which may indicate the collision. The post-collision indication may be a detected conflict indication. The second UE may retransmit the second sidelink transmission based at least in part on the post-collision indication. Further, the first UE may retransmit the first sidelink transmission. A transmission of the post-collision indication may trigger retransmissions by the first UE and the second UE.

As shown by reference number 406, a half-duplex collision may occur at a second UE, based at least in part on a half-duplex capability of the second UE (e.g., the second UE cannot receive and transmit at a same time). A first UE may transmit to the second UE a half-duplex indication to indicate the half-duplex collision. The second UE may retransmit a second sidelink transmission based at least in part on the half-duplex indication. Further, the first UE may retransmit a first sidelink transmission. A transmission of the half-duplex indication may trigger retransmissions by the first UE and the second UE.

As indicated above, FIG. 4 is provided as an example. Other examples may differ from what is described with regard to FIG. 4.

In a first scheme of inter-UE coordination, coordination information transmitted from a first UE to a second UE may indicate a set of resources preferred and/or non-preferred for the second UE's transmission. The coordination information may indicate a preferred resource set and/or a non-preferred resource set. The coordination information may indicate a time and/or frequency of resources within the preferred resource set and/or the non-preferred resource set. In a second scheme of inter-UE coordination, the coordination information transmitted from the first UE to the second UE may indicate a presence of an expected/potential conflict and/or a detected resource conflict with respect to resources indicated by the second UE's SCI.

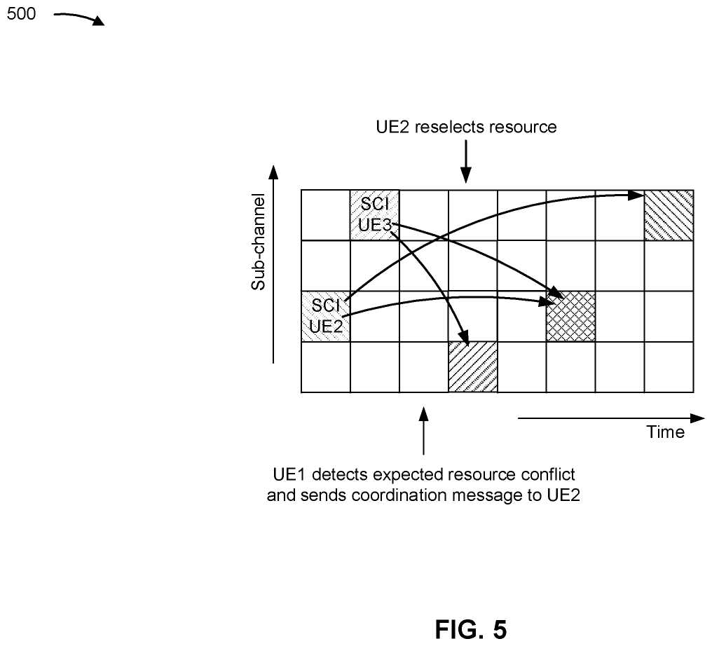

FIG. 5 is a diagram illustrating an example 500 of signaling a presence of an expected/potential resource conflict, in accordance with the present disclosure.

As shown in FIG. 5, a second UE (UE2) may transmit SCI indicating an upcoming resource for a sidelink transmission from the second UE. A third UE (UE3) may transmit SCI indicating an upcoming resource for a sidelink transmission from the third UE. A first UE (UE1) may receive the SCI from the second UE and the SCI from the third UE, and based at least in part on SCIs from the second UE and the third UE, respectively, the first UE may determine that an expected resource conflict may occur between the sidelink transmission from the second UE and the sidelink transmission from the third UE. The first UE may transmit inter-UE coordination information to the second UE, and the second UE may reselect a resource for its sidelink transmission based at least in part on the inter-UE coordination information.

The first UE may transmit, via the inter-UE coordination information, an indication that indicates the expected resource conflict. In other words, the indication may indicate a presence of an expected/potential resource conflict on resources indicated by the second UE's SCI. The first UE may transmit the indication using a container/signaling format. The container/signaling format may be associated with a PSFCH-like signaling, a sidelink control information stage 1 (SCI-1), a sidelink control information stage 2, or a PSFCH.

As indicated above, FIG. 5 is provided as an example. Other examples may differ from what is described with regard to FIG. 5.

A first UE may transmit inter-UE coordination information to a second UE. The inter-UE coordination information may indicate a presence of an expected/potential resource conflict and/or a detected resource conflict on resources indicated by an SCI transmitted by the second UE. After receiving the inter-UE coordination information from the first UE, the second UE may perform one of several options. For example, the second UE may determine resource(s) to be reselected based at least in part on the inter-UE coordination information received from the first UE. As another example, the UE may determine a necessity of retransmission based at least in part on the inter-UE coordination information received from the first UE.

In some cases, the first UE may detect multiple resource conflicts based at least in part on SCI received from multiple UEs including the second UE. The first UE may prepare multiple resource conflict indications but may not be configured to prioritize the multiple resource conflict indications for transmission to the second UE. The multiple resource conflict indications may include expected/potential conflict indications and/or detected conflict indications. The first UE may not be configured to consider a packet priority when prioritizing the multiple resource conflict indications. Further, the first UE may transmit a resource conflict indication with a transmission power level that causes in-band emissions (IBE) leakage to hybrid automatic repeat request acknowledgement (HARQ-ACK) feedback transmitted on a PSFCH, which may be associated with a higher priority as compared to the resource conflict indication.

In various aspects of techniques and apparatuses described herein, the first UE may receive SCI from multiple UEs including the second UE. The first UE may select, from multiple resource conflict indications derived from the SCI, a resource conflict indication based at least in part on a priority scheme. The multiple resource conflict indications may include an expected/potential conflict indication and a detected conflict indication. In some aspects, the first UE may select the expected/potential conflict indication from the multiple resource conflict indications in accordance with the priority scheme, where the expected/potential conflict indication may be prioritized over the detected conflict indication in accordance with the priority scheme. In some aspects, the first UE may select the detected conflict indication from the multiple resource conflict indications in accordance with the priority scheme, where the detected conflict indication may be prioritized over the expected/potential conflict indication in accordance with the priority scheme. The first UE may transmit, to at least one of the multiple UEs including the second UE, the resource conflict indication in accordance with a transmission power level. The first UE may select the transmission power level to be less than a transmission power level associated with a PSFCH carrying a HARQ-ACK feedback. As a result, the first UE may be configured to select the resource conflict indication from the multiple resource conflict indications in accordance with the priority scheme, and the first UE may transmit the resource conflict indication with the transmission power level while preventing IBE leakage to the HARQ-ACK feedback on the PSFCH, which may be associated with a higher priority as compared to the resource conflict indication.

FIG. 6 is a diagram illustrating an example 600 associated with resource conflict indications for sidelink resources, in accordance with the present disclosure. As shown in FIG. 6, example 600 includes communication between a first UE (e.g., UE 120a) and a second UE (e.g., UE 120e). In some aspects, the first UE and the second UE may be included in a wireless network, such as wireless network 100.

As shown by reference number 602, the first UE may receive SCI (e.g., SCI-1 and/or SCI-2) from multiple UEs including the second UE. The SCI may indicate a resource reservation for an upcoming sidelink transmission. For example, SCI transmitted by the second UE may indicate resource reservations for upcoming sidelink transmissions by the second UE. The SCI may be multiple SCIs received from the multiple UEs, where each respective SCI received from a particular UE may include an SCI-1 and/or an SCI-2. For example, the first UE may receive one SCI from the second UE, another SCI from a third UE, and so on, such that each of the second UE and the third UE may transmit separate SCI which may be received at the first UE. The first UE may receive each SCI in a PDCCH, in a downlink control information (DCI), and/or in a separate message.

As shown by reference number 604, the first UE may select, from multiple resource conflict indications derived from the multiple SCIs, a resource conflict indication based at least in part on a priority scheme. In some aspects, a HARQ-ACK feedback may be prioritized over the resource conflict indication in accordance with the priority scheme. In some aspects, the multiple resource conflict indications may include an expected/potential conflict indication and a detected conflict indication, and the selected resource conflict indication may be either the expected/potential conflict indication or the detected conflict indication. The first UE may select the expected/potential conflict indication in accordance with the priority scheme, where the expected/potential conflict indication may be prioritized over the detected conflict indication in accordance with the priority scheme. Alternatively, the first UE may select the detected conflict indication in accordance with the priority scheme, where the detected conflict indication may be prioritized over the expected/potential conflict indication in accordance with the priority scheme.

In some aspects, the resource conflict indication may be derived based at least in part on the multiple SCIs received from the multiple UEs (or from a single SCI received from the second UE). In some aspects, the resource conflict indication may be based at least in part on a single detected conflict between the first UE and the second UE. In some aspects, the resource conflict indication may be the expected/potential conflict indication. The expected/potential conflict indication may indicate that a conflict is expected or may potentially occur between the first UE and the second UE, based at least in part on the SCI transmitted by the second UE. For example, the SCI transmitted by the second UE may indicate an upcoming transmission, and the first UE may determine that the upcoming transmission of the second UE may conflict with an upcoming transmission of the first UE. In some aspects, the resource conflict indication may be the detected conflict indication. The detected conflict indication may indicate that a conflict has already occurred between the first UE and the second UE, based at least in part on the SCI transmitted by the second UE. For example, the SCI transmitted by the second UE may indicate a transmission, and the first UE may determine that the transmission of the second UE may conflict with a transmission of the first UE. In this case, the first UE may only transmit the detected conflict indication after the transmission of the first UE has already conflicted with the transmission of the second UE. The detected conflict indication may be transmitted after a conflict between transmissions between the first UE and the second UE, whereas the expected/potential conflict indication may be transmitted prior to a conflict between transmissions between the first UE and the second UE.

In some aspects, the first UE may transmit the resource conflict indication to the second UE based at least in part on the SCI received from the second UE. The first UE may transmit the resource conflict indication in accordance with the priority scheme. In some aspects, the first UE may prioritize HARQ-ACK feedback over expected/potential conflict indications and detected conflict indications. In some aspects, the first UE may prioritize expected/potential conflict indications over detected conflict indications. Indications of detected conflicts may be transmitted over the PSFCH (e.g., as indications of packet decoding failures). Since the multiple UEs are more likely to transmit indications of detected conflicts to the second UE, the expected/potential conflict indications may be prioritized over the detected conflict indications. In some aspects, the first UE may prioritize detected conflict indications over expected/potential conflict indications. Expected/potential conflict indications may trigger resource selections from the second UE, while detected conflict indications may trigger retransmissions from the second UE (similar to HARQ-ACK feedback-based retransmissions). As a result, detected conflict indications may introduce less system disturbance, and thus may be prioritized over the expected/potential conflict indications.

In some aspects, the first UE may select the resource conflict indication from the multiple resource conflict indications irrespective of a packet priority associated with the resource conflict indication. Alternatively, the first UE may select the resource conflict indication from the multiple resource conflict indications based at least in part on the packet priority associated with each of the multiple resource conflict indications, where the packet priority may be indicated in the multiple SCIs received from the multiple UEs. In some aspects, the multiple resource conflict indications may each be associated with a same packet priority, in which case the UE may select the resource conflict indication from the multiple resource conflict indications based at least in part on a type of conflict indication (e.g., expected/potential conflict indication versus detected conflict indication).

In some aspects, resource conflict indications may indicate detected conflict resources associated with packets of different priorities. In some aspects, a priority of the resource conflict indications may be decoupled or independent from the packet priority. For example, the first UE may select from the multiple resource conflict indications based at least in part on indication types (e.g., expected/potential conflict indication versus detected conflict indication), regardless of the packet priority. The first UE may select from the multiple resource conflict indications depending on whether the conflict indications are associated with expected/potential conflicts or detected conflicts. In some aspects, the first UE may decode the SCI received from the second UE, and the first UE may transmit a specific resource conflict indication from the multiple resource conflict indications based at least in part on a packet priority indicated by the SCI. In this case, the first UE may transmit a resource conflict indication to the second UE for a higher priority packet as opposed to lower priority packets, and the second UE may transmit the highest priority packet based at least in part on the resource conflict indication received from the first UE. In some aspects, the first UE may detect the multiple resource conflict indications associated with a same packet priority, and in this case, the first UE may select from the multiple resource conflict indications associated with the same packet priority depending on whether the resource conflict indications are associated with expected/potential conflicts or detected conflicts.

As shown by reference number 606, the first UE may transmit, to at least one of the multiple UEs including the second UE, the resource conflict indication in accordance with a transmission power level. The first UE may select the transmission power level for transmitting the resource conflict indication, such that the transmission power level may be less than a transmission power level associated with a PSFCH carrying a HARQ-ACK feedback.

In some aspects, the first UE may transmit the resource conflict indication to at least one of the multiple UEs including the second UE in accordance with the transmission power level. The transmission power level used for transmitting the resource conflict indication may be lower than the transmission power level used for transmitting the PSFCH carrying the HARQ-ACK feedback, where the PSFCH carrying the HARQ-ACK feedback may be transmitted by the first UE or the second UE. The first UE may be enabled with a power reduction when transmitting the resource conflict indication to at least one of the multiple UEs including the second UE. The transmission power level for transmitting the resource conflict indication may be (pre-) configured for the UE or based at least in part on UE implementation. For example, the UE may apply an X dB maximum power reduction when transmitting the resource conflict indication. By transmitting the resource conflict indication at the lower transmission power level, as compared to the PSFCH carrying the HARQ-ACK feedback, the first UE may prevent IBE leakage to the HARQ-ACK feedback transmitted on the PSFCH, which may be associated with a higher priority as compared to the resource conflict indication. Further, a distance between the first UE and the second UE when transmitting the resource conflict indication may typically be smaller than when transmitting the HARQ-ACK feedback on the PSFCH, so the transmission power level used for transmitting the resource conflict indication may be lower than the transmission power level used for transmitting the PSFCH carrying the HARQ-ACK feedback.

As indicated above, FIG. 6 is provided as an example. Other examples may differ from what is described with regard to FIG. 6.

FIG. 7 is a diagram illustrating an example process 700 performed, for example, by a first UE, in accordance with the present disclosure. Example process 700 is an example where the first UE (e.g., UE 120a) performs operations associated with resource conflict indications for sidelink resources.

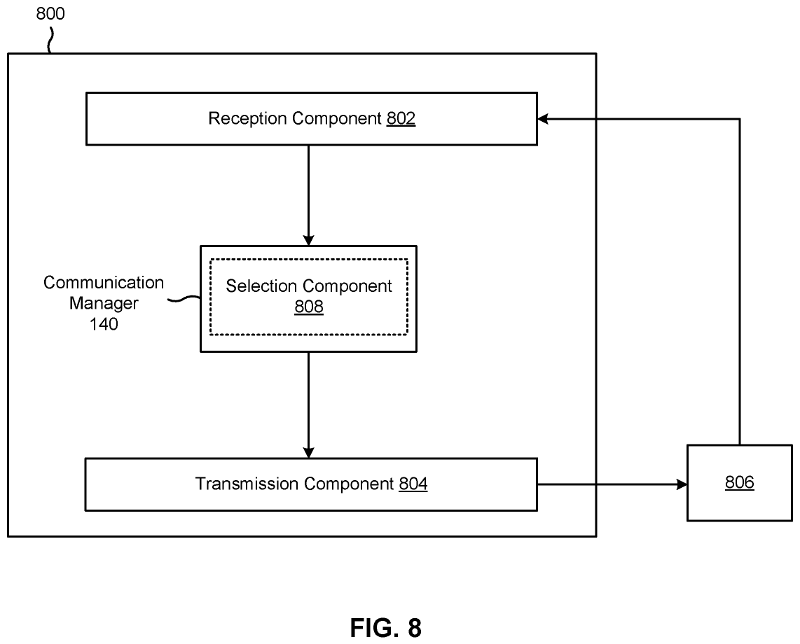

As shown in FIG. 7, in some aspects, process 700 may include receiving multiple SCIs from multiple UEs including a second UE (block 710). For example, the first UE (e.g., using communication manager 140 and/or reception component 802, depicted in FIG. 8) may receive multiple SCIs from multiple UEs including a second UE, as described above.

As further shown in FIG. 7, in some aspects, process 700 may include selecting, from multiple resource conflict indications derived from the multiple SCIs, a resource conflict indication based at least in part on a priority scheme (block 720). For example, the UE (e.g., using communication manager 140 and/or selection component 808, depicted in FIG. 8) may select, from multiple resource conflict indications derived from the multiple SCIs, a resource conflict indication based at least in part on a priority scheme, as described above.

As further shown in FIG. 7, in some aspects, process 700 may include transmitting, to at least one of the multiple UEs including the second UE, the resource conflict indication in accordance with a transmission power level (block 730). For example, the UE (e.g., using communication manager 140 and/or transmission component 804, depicted in FIG. 8) may transmit, to at least one of the multiple UEs including the second UE, the resource conflict indication in accordance with a transmission power level, as described above.

Process 700 may include additional aspects, such as any single aspect or any combination of aspects described below and/or in connection with one or more other processes described elsewhere herein.

In a first aspect, process 700 includes selecting the transmission power level for transmitting the resource conflict indication, wherein the transmission power level is less than a transmission power level associated with a PSFCH carrying a HARQ-ACK feedback configured to be transmitted by the first UE.

In a second aspect, alone or in combination with the first aspect, a HARQ-ACK feedback is prioritized over the resource conflict indication in accordance with the priority scheme.

In a third aspect, alone or in combination with one or more of the first and second aspects, the multiple resource conflict indications include an expected/potential conflict indication and a detected conflict indication.

In a fourth aspect, alone or in combination with one or more of the first through third aspects, process 700 includes selecting the expected/potential conflict indication in accordance with the priority scheme, wherein the expected/potential conflict indication is prioritized over the detected conflict indication in accordance with the priority scheme.

In a fifth aspect, alone or in combination with one or more of the first through fourth aspects, process 700 includes selecting the detected conflict indication in accordance with the priority scheme, wherein the detected conflict indication is prioritized over the expected/potential conflict indication in accordance with the priority scheme.

In a sixth aspect, alone or in combination with one or more of the first through fifth aspects, process 700 includes selecting the resource conflict indication from the multiple resource conflict indications irrespective of a packet priority associated with the resource conflict indication.

In a seventh aspect, alone or in combination with one or more of the first through sixth aspects, process 700 includes selecting the resource conflict indication from the multiple resource conflict indications based at least in part on a packet priority associated with each of the multiple resource conflict indications, wherein the packet priority is indicated in the multiple SCIs received from the multiple UEs.

In an eighth aspect, alone or in combination with one or more of the first through seventh aspects, the multiple resource conflict indications are each associated with a same packet priority.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a first UE, or a first UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include a selection component 808, among other examples.

In some aspects, the apparatus 800 may be configured to perform one or more operations described herein in connection with FIG. 6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the first UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the first UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the first UE described in connection with FIG. 2. In some aspects, the transmission component 804 may be co-located with the reception component 802 in a transceiver.

The reception component 802 may receive multiple SCIs from multiple UEs including a second UE. The selection component 808 may select, from multiple resource conflict indications derived from the multiple SCIs, a resource conflict indication based at least in part on a priority scheme. The transmission component 804 may transmit, to at least one of the multiple UEs including the second UE, the resource conflict indication in accordance with a transmission power level.

The selection component 808 may select the transmission power level for transmitting the resource conflict indication, wherein the transmission power level is less than a transmission power level associated with a PSFCH carrying a HARQ-ACK feedback configured to be transmitted by the first UE. The selection component 808 may select an expected/potential conflict indication in accordance with the priority scheme, wherein the expected/potential conflict indication is prioritized over the detected conflict indication in accordance with the priority scheme. The selection component 808 may select a detected conflict indication in accordance with the priority scheme, wherein the detected conflict indication is prioritized over the expected/potential conflict indication in accordance with the priority scheme. The selection component 808 may select the resource conflict indication from the multiple resource conflict indications irrespective of a packet priority associated with the resource conflict indication. The selection component 808 may select the resource conflict indication from the multiple resource conflict indications based at least in part on a packet priority associated with each of the multiple resource conflict indications, wherein the packet priority is indicated in the multiple SCIs received from the multiple UEs

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a first user equipment (UE), comprising: receiving, from multiple UEs including a second UE, multiple sidelink control informations (SCIs): selecting, from multiple resource conflict indications derived from the multiple SCIs, a resource conflict indication based at least in part on a priority scheme; and transmitting, to at least one of the multiple UEs including the second UE, the resource conflict indication in accordance with a transmission power level.

Aspect 2: The method of Aspect 1, further comprising: selecting the transmission power level for transmitting the resource conflict indication, wherein the transmission power level is less than a transmission power level associated with a physical sidelink feedback channel carrying a hybrid automatic repeat request acknowledgement feedback configured to be transmitted by the first UE.

Aspect 3: The method of any of Aspects 1 through 2, wherein a hybrid automatic repeat request acknowledgement feedback is prioritized over the resource conflict indication in accordance with the priority scheme.

Aspect 4: The method of any of Aspects 1 through 3, wherein the multiple resource conflict indications include an expected or potential conflict indication and a detected conflict indication.

Aspect 5: The method of Aspect 4, further comprising selecting the expected or potential conflict indication in accordance with the priority scheme, wherein the expected or potential conflict indication is prioritized over the detected conflict indication in accordance with the priority scheme.

Aspect 6: The method of Aspect 4, further comprising selecting the detected conflict indication in accordance with the priority scheme, wherein the detected conflict indication is prioritized over the expected or potential conflict indication in accordance with the priority scheme.

Aspect 7: The method of any of Aspects 1 through 6, wherein selecting the resource conflict indication based at least in part on the priority scheme comprises selecting the resource conflict indication from the multiple resource conflict indications irrespective of a packet priority associated with the resource conflict indication.

Aspect 8: The method of any of Aspects 1 through 7, wherein selecting the resource conflict indication based at least in part on the priority scheme comprises selecting the resource conflict indication from the multiple resource conflict indications based at least in part on a packet priority associated with each of the multiple resource conflict indications, wherein the packet priority is indicated in the multiple SCIs received from the multiple UEs.

Aspect 9: The method of any of Aspects 1 through 8, wherein the multiple resource conflict indications are each associated with a same packet priority.

Aspect 10: An apparatus for wireless communication at a device, comprising a processor: memory coupled with the processor; and instructions stored in the memory and executable by the processor to cause the apparatus to perform the method of one or more of Aspects 1-9.

Aspect 11: A device for wireless communication, comprising a memory and one or more processors coupled to the memory, the one or more processors configured to perform the method of one or more of Aspects 1-9.

Aspect 12: An apparatus for wireless communication, comprising at least one means for performing the method of one or more of Aspects 1-9.

Aspect 13: A non-transitory computer-readable medium storing code for wireless communication, the code comprising instructions executable by a processor to perform the method of one or more of Aspects 1-9.

Aspect 14: A non-transitory computer-readable medium storing a set of instructions for wireless communication, the set of instructions comprising one or more instructions that, when executed by one or more processors of a device, cause the device to perform the method of one or more of Aspects 1-9.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a first user equipment (UE), comprising:
a memory; and
one or more processors, coupled to the memory, configured to:
receive, from multiple UEs including a second UE, multiple sidelink control informations (SCIs);
select, from multiple resource conflict indications derived from the multiple SCIs, a resource conflict indication based at least in part on a priority scheme; and
transmit, to at least one of the multiple UEs including the second UE, the resource conflict indication in accordance with a transmission power level.

2. The apparatus of claim 1, wherein the one or more processors are further configured to:
select the transmission power level for transmitting the resource conflict indication, wherein the transmission power level is less than a transmission power level associated with a physical sidelink feedback channel carrying a hybrid automatic repeat request acknowledgement feedback configured to be transmitted by the first UE.

3. The apparatus of claim 1, wherein a hybrid automatic repeat request acknowledgement feedback is prioritized over the resource conflict indication in accordance with the priority scheme.

4. The apparatus of claim 1, wherein the multiple resource conflict indications include an expected or potential conflict indication and a detected conflict indication.

5. The apparatus of claim 4, wherein the one or more processors are further configured to select the expected or potential conflict indication in accordance with the priority scheme, wherein the expected or potential conflict indication is prioritized over the detected conflict indication in accordance with the priority scheme.

6. The apparatus of claim 4, wherein the one or more processors are further configured to select the detected conflict indication in accordance with the priority scheme, wherein the detected conflict indication is prioritized over the expected or potential conflict indication in accordance with the priority scheme.

7. The apparatus of claim 1, wherein the one or more processors, to select the resource conflict indication based at least in part on the priority scheme, are configured to select the resource conflict indication from the multiple resource conflict indications irrespective of a packet priority associated with the resource conflict indication.

8. The apparatus of claim 1, wherein the one or more processors, to select the resource conflict indication based at least in part on the priority scheme, are configured to select the resource conflict indication from the multiple resource conflict indications based at least in part on a packet priority associated with each of the multiple resource conflict indications, wherein the packet priority is indicated in the multiple SCIs received from the multiple UEs.

9. The apparatus of claim 1, wherein the multiple resource conflict indications are each associated with a same packet priority.

10. A method of wireless communication performed by a first user equipment (UE), comprising:
receiving, from multiple UEs including a second UE, multiple sidelink control informations (SCIs);
selecting, from multiple resource conflict indications derived from the multiple SCIs, a resource conflict indication based at least in part on a priority scheme; and
transmitting, to at least one of the multiple UEs including the second UE, the resource conflict indication in accordance with a transmission power level.

11. The method of claim 10, further comprising:
selecting the transmission power level for transmitting the resource conflict indication, wherein the transmission power level is less than a transmission power level associated with a physical sidelink feedback channel carrying a hybrid automatic repeat request acknowledgement feedback configured to be transmitted by the first UE.

12. The method of claim 10, wherein a hybrid automatic repeat request acknowledgement feedback is prioritized over the resource conflict indication in accordance with the priority scheme.

13. The method of claim 10, wherein the multiple resource conflict indications include an expected or potential conflict indication and a detected conflict indication.

14. The method of claim 13, further comprising selecting the expected or potential conflict indication in accordance with the priority scheme, wherein the expected or potential conflict indication is prioritized over the detected conflict indication in accordance with the priority scheme.

15. The method of claim 13, further comprising selecting the detected conflict indication in accordance with the priority scheme, wherein the detected conflict indication is prioritized over the expected or potential conflict indication in accordance with the priority scheme.

16. The method of claim 10, wherein selecting the resource conflict indication based at least in part on the priority scheme comprises selecting the resource conflict indication from the multiple resource conflict indications irrespective of a packet priority associated with the resource conflict indication.

17. The method of claim 10, wherein selecting the resource conflict indication based at least in part on the priority scheme comprises selecting the resource conflict indication from the multiple resource conflict indications based at least in part on a packet priority associated with each of the multiple resource conflict indications, wherein the packet priority is indicated in the multiple SCIs received from the multiple UEs.

18. The method of claim 10, wherein the multiple resource conflict indications are each associated with a same packet priority.

19. A non-transitory computer-readable medium storing a set of instructions for wireless communication, the set of instructions comprising:
one or more instructions that, when executed by one or more processors of a first user equipment (UE), cause the first UE to:
receive, from multiple UEs including a second UE, multiple sidelink control informations (SCIs);
select, from multiple resource conflict indications derived from the multiple SCIs, a resource conflict indication based at least in part on a priority scheme; and
transmit, to at least one of the multiple UEs including the second UE, the resource conflict indication in accordance with a transmission power level.

20. The non-transitory computer-readable medium of claim 19, wherein the one or more instructions further cause the first UE to:
select the transmission power level for transmitting the resource conflict indication, wherein the transmission power level is less than a transmission power level associated with a physical sidelink feedback channel carrying a hybrid automatic repeat request acknowledgement feedback configured to be transmitted by the first UE.

21. The non-transitory computer-readable medium of claim 19, wherein a hybrid automatic repeat request acknowledgement feedback is prioritized over the resource conflict indication in accordance with the priority scheme, and wherein the multiple resource conflict indications include an expected or potential conflict indication and a detected conflict indication.

22. The non-transitory computer-readable medium of claim 21, wherein the one or more instructions further cause the first UE to select the expected or potential conflict indication in accordance with the priority scheme, wherein the expected or potential conflict indication is prioritized over the detected conflict indication in accordance with the priority scheme, or wherein the detected conflict indication is prioritized over the expected or potential conflict indication in accordance with the priority scheme.

23. The non-transitory computer-readable medium of claim 19, wherein the one or more instructions, that cause the first UE to select the resource conflict indication based at least in part on the priority scheme, cause the first UE to select the resource conflict indication from the multiple resource conflict indications irrespective of a packet priority associated with the resource conflict indication.

24. The non-transitory computer-readable medium of claim 19, wherein the one or more instructions, that cause the first UE to select the resource conflict indication based at least in part on the priority scheme, cause the first UE to select the resource conflict indication from the multiple resource conflict indications based at least in part on a packet priority associated with each of the multiple resource conflict indications, wherein the packet priority is indicated in the multiple SCIs received from the multiple UEs.

25. A first apparatus for wireless communication, comprising:
means for receiving, from multiple apparatuses including a second apparatus, multiple sidelink control informations (SCIs);
means for selecting, from multiple resource conflict indications derived from the multiple SCIs, a resource conflict indication based at least in part on a priority scheme; and
means for transmitting, to the second apparatus, the resource conflict indication in accordance with a transmission power level.

26. The first apparatus of claim 25, further comprising:
means for selecting the transmission power level for transmitting the resource conflict indication, wherein the transmission power level is less than a transmission power level associated with a physical sidelink feedback channel carrying a hybrid automatic repeat request acknowledgement feedback configured to be transmitted by the first apparatus.

27. The first apparatus of claim 25, wherein a hybrid automatic repeat request acknowledgement feedback is prioritized over the resource conflict indication in accordance with the priority scheme, and wherein the multiple resource conflict indications include an expected or potential conflict indication and a detected conflict indication.

28. The first apparatus of claim 27, further comprising means for selecting the expected or potential conflict indication in accordance with the priority scheme, wherein the expected or potential conflict indication is prioritized over the detected conflict indication in accordance with the priority scheme, or wherein the detected conflict indication is prioritized over the expected or potential conflict indication in accordance with the priority scheme.

29. The first apparatus of claim 25, wherein the means for selecting the resource conflict indication based at least in part on the priority scheme comprises means for selecting the resource conflict indication from the multiple resource conflict indications irrespective of a packet priority associated with the resource conflict indication.

30. The first apparatus of claim 25, wherein the means for selecting the resource conflict indication based at least in part on the priority scheme comprises means for selecting the resource conflict indication from the multiple resource conflict indications based at least in part on a packet priority associated with each of the multiple resource conflict indications, wherein the packet priority is indicated in the multiple SCIs received from the multiple apparatuses.
